(19) United States
(12) Patent Application Publication
(10) Pub. No.: US 2009/0273844 A1
(43) Pub. Date: Nov. 5, 2009

(54) Privacy Filter With Rounded Optically Opaque Regions

(76) Inventors: Jung Suk Lee, Houston, TX (US); Fred C. Thomas, Fort Collins, CO (US); Paul M. Hupman, Magnolia, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/242,402

(22) Filed: Sep. 30, 2008

Related U.S. Application Data
(60) Provisional application No. 61/049,256, filed on Apr. 30, 2008.

(51) Int. Cl. G02B 27/00; G02B 5/22

(52) U.S. Cl. 359/601; 359/885; 359/614

(57) ABSTRACT

A privacy filter comprises a first light transmissive film having a first plurality of rounded, optically opaque regions extending into a surface thereof. The first plurality of rounded, optically opaque regions are positioned to allow a viewer to view an image through the privacy filter within a range of viewing angles and to block viewing of the image through the privacy filter outside the range of viewing angles.

### CROSS REFERENCE TO RELATED APPLICATIONS

This application claims the benefit of provisional patent application Ser. No. 61/049,256, filed Apr. 30, 2008, titled “Privacy Filter With Rounded Optically Opaque Regions.”

### BACKGROUND

Privacy filters are light control devices that generally provide lateral privacy for a computer user. That is, an observer off to one side or the other of the computer display will be unable to adequately read what is being displayed. Such privacy filters, however, generally do not provide privacy from an observer standing behind the computer user and looking down at the user's display.

### BRIEF DESCRIPTION OF THE DRAWINGS

For a detailed description of exemplary embodiments of the invention, reference will now be made to the accompanying drawings in which:

FIG. 1 shows a front view of a privacy in accordance with embodiments of the invention illustrating the circular configuration of the privacy elements;

FIG. 2 shows a cut away view of the privacy filter in accordance with various embodiments; and

FIG. 3 shows another cut away view of the privacy filter in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to. . . . ”

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

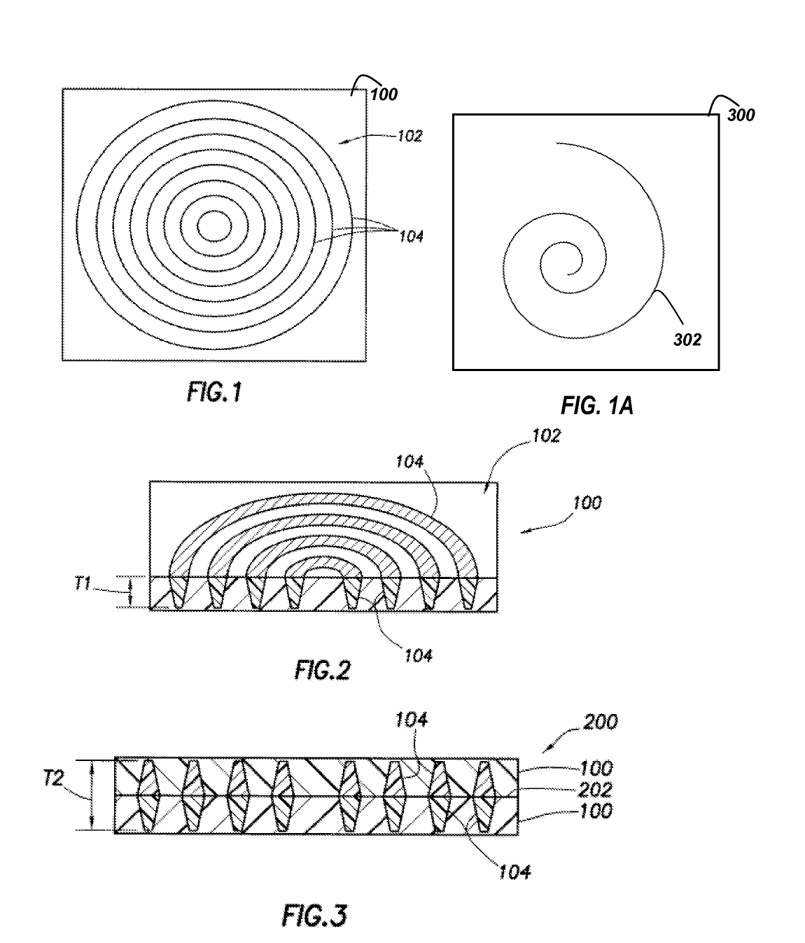

FIG. 1 shows a privacy filter 100 in accordance with various embodiments. As shown, the privacy filter 100 comprises a film 102 that transmits light therethrough. The light transmissive film 102 appears transparent to a user so that, when the privacy filter 100 is placed on (e.g., adhered to) a display (e.g., computer monitor), the user can read the information provided on the display. The light transmissive film 102 comprises a plurality of optically opaque regions 104. Each optically opaque region 104 comprises a self-contained shape, at least a portion of which in the plane defined by film 102 has a curved portion. In some embodiments, the entirety of each optically opaque region is curved (i.e., the region is rounded). In the embodiment of FIG. 1, each optically opaque region 104 is circular, but in general can be any shape, at least a portion of which is curved, such as elliptical, circular, and ovoidal. In some embodiments, the optically opaque regions 104 comprise a plurality of concentrically arranged regions. In other embodiments, the optically opaque region 104 is a single spiral groove.

The optically opaque regions 104 are generally very thin, and thus when the privacy filter 100 is viewed orthogonal to the plane of the filter, the optically opaque regions generally cannot be seen. As such, a user can view the display through the privacy filter 100 generally unimpeded by the optically opaque regions 104.

FIG. 2 shows an exaggerated, cross-sectional, perspective view of the film 102 and optically opaque regions 104 contained therein. Each optically opaque region 104 extends into the surface of the film 102 albeit preferably not all of the way through the film. Each optically opaque region comprises a groove having a tapered shape as shown. A suitable optically opaque material is disposed in each groove. Examples of suitable optically opaque materials comprise light absorbing materials or light blocking materials. Suitable materials include a black dye.

The light transmissive film 102 can be made from any suitable light transparent material into which the grooves containing the optically opaque material can be formed. In some embodiments, the film 102 comprises plastic. The film preferably is molded, cast, extruded or otherwise machined to have the plurality of grooves into which the optically opaque material is deposited (e.g., filled, coated, etc.).

The side walls of the tapered grooves in FIG. 2 can be flat as shown or, in other embodiments, curved. The rounded nature of the optically opaque regions 104 explained herein refers to the shape of the regions when viewed from on top as in FIG. 1. That is, the shape of the grooves across the surface of the film is rounded.

In some embodiments, a single layer of film 102 is suitable for providing lateral and vertical privacy. When a user views the privacy filter 100 from an angle that differs substantially from 90 degrees, the user will be unable to adequately see through the privacy filter 100 due to the thickness T1 of the optically opaque regions 104. The rounded (e.g., elliptical) nature of the optically opaque regions provides privacy from an errant gaze from the sides, top or bottom. The spacing between, and the thickness of, the optically opaque regions defines the viewing angle of the privacy filter 100 (the angle through which filter permits adequate viewing).

FIG. 3 illustrates an embodiment of a two-piece privacy filter 200. The privacy filter 200 comprises two films 100 bonded together using, for example, an optically transparent adhesive 202. Each film 100 is the same as or similar to the films 100 shown in FIGS. 1 and 2. The films 100 are bonded together such that the optically opaque regions 104 substantially align as shown. This embodiment effectively increases the thickness of the optically opaque regions to a distance of T2 which is generally twice that of T1.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A privacy filter, comprising:
a first light transmissive film comprising a first plurality of rounded, optically opaque regions extending into a surface thereof; and
a second light transmissive film disposed adjacent the first light transmissive film and comprising a second plurality of rounded, optically opaque regions extending into a surface thereof,
wherein the first plurality of rounded, optically opaque regions and the second plurality of rounded, optically opaque regions are positioned to allow a viewer to view an image through the privacy filter within a range of viewing angles and to block viewing of the image through the privacy filter outside the range of viewing angles.

2. The privacy filter of claim 1 wherein the first plurality of rounded, optically opaque regions comprises concentrically arranged opaque rings of circular absorbing regions.

3. The privacy filter of claim 1 wherein the second plurality of rounded, optically opaque regions comprises concentrically arranged opaque rings.

4. The privacy filter of claim 1 wherein the first and second pluralities of rounded, optically opaque regions comprise concentrically arranged opaque rings and the concentrically arranged opaque rings of the first plurality of rounded, optically opaque regions is aligned with the second plurality of rounded, optically opaque regions.

5. The privacy filter of claim 1 wherein the first and second pluralities of rounded, optically opaque regions have a shape selected from a group consisting of elliptical, circular, and ovoidal.

6. The privacy filter of claim 1 wherein first and second pluralities of rounded, optically opaque regions are aligned.

7. The privacy filter of claim 1 wherein the first and second pluralities of rounded, optically opaque regions have a spiral shape.

8. A privacy filter, comprising:
a first light transmissive film comprising a first plurality of optically opaque regions extending into a surface thereof, wherein the first plurality of optically opaque regions are positioned to allow a viewer to view an image through the privacy filter within a range of viewing angles and to block viewing of the image through the privacy filter outside the range of viewing angles;
wherein each of the first plurality of optically opaque regions has a curved portion.

9. The privacy filter of claim 8 further comprising a second light transmissive film disposed adjacent the first light transmissive film and comprising a second plurality of optically opaque regions extending into a surface thereof, each of the second plurality of optically opaque regions has a curved portion.

10. The privacy filter of claim 8 wherein the first plurality of optically opaque regions comprises concentrically arranged opaque rings of circular absorbing regions.

11. The privacy filter of claim 8 wherein the first plurality of optically opaque regions have a shape selected from a group consisting of elliptical, circular, and ovoidal.

12. The privacy filter of claim 8 wherein the first plurality of optically opaque regions are rounded.
